(19) United States
(12) Patent Application Publication
(10) Pub. No.: US 2026/0328249 A1
(43) Pub. Date: Oct. 22, 2026

(54) FOIL THRUST BEARING AND METHOD OF FITTING A FOIL THRUST BEARING

(71) Applicant: Robert Bosch GmbH, Stuttgart (DE)

(72) Inventors: Michael Kurrle, Ludwigsburg (DE); Thomas Nierychlo, Osterode Am Harz (DE)

(21) Appl. No.: 19/114,148

(22) PCT Filed: Aug. 4, 2023
(86) PCT No.: PCT/EP2023/071638

§ 371 Date: Mar. 21, 2025

(30) Foreign Application Priority Data
Sep. 30, 2022 (DE) 10 2022 210 412.9

(51) Int. Cl. F16C 41/00; F16C 17/04

(52) U.S. Cl. CPC F16C 41/008; F16C 17/042

(57) ABSTRACT

The invention relates to a foil thrust bearing (1) having different bearing foils (11-14; 21-24) which are fitted in a defined position and in a specific order on two sides of an axial intermediate space (8).

In order to simplify the assembly of the foil thrust bearing (1), the different bearing foils (11-14; 21-24) are provided with additional identifiers which are visible in a defined identifier arrangement on the different bearing foils (11-14; 21-24) only when the different bearing foils (11-14; 21-24) are fitted in a correct fitting order and are correctly positioned.

### BACKGROUND

The invention relates to a foil thrust bearing with different bearing foils that are fitted in a defined position and in a specific order on two sides of an axial intermediate space. The invention also relates to a method for fitting such a foil thrust bearing.

German publication DE 10 2019 200 330 A1 discloses a rotor bearing system for a turbomachine, wherein the rotor bearing system comprises at least: an axial foil air bearing comprising at least one covering foil axially spaced from a support means and at least one spring foil arranged between the covering foil and the support means; and a rotor abutting against the covering foil of the axial foil air bearing and rotatable relative to the axial foil air bearing. A foil thrust bearing for fuel cell systems is known from the German Disclosure document DE 10 2019 200 331 A1, wherein the foil thrust bearing comprises a pressure washer having at least one covering foil arranged in the peripheral direction on the pressure washer, and a spring foil arranged between the pressure washer and the covering foil.

### SUMMARY

The object of the invention is to simplify the assembly of a foil thrust bearing with different bearing foils, which are fitted in a defined position and in a specific order on two sides of an axial intermediate space.

In the case of a foil thrust bearing with different bearing foils, which are fitted in a defined position and in a specific order on two sides of an axial intermediate space, is solved by the different bearing foils being provided with additional identifiers, which are only visible on the different bearing foils in a defined identifier arrangement when the different bearing foils are fitted in a correct fitting order and positioned correctly. This is an easy way to ensure that the various bearing foils in the foil thrust bearing can fully perform their assigned functions. The individual bearing foils with the additional identifiers are designed in such a way that a poka-yoke assembly of the individual bearing foils is made possible.

A preferred exemplary embodiment of the foil thrust bearing is characterized in that the different bearing foils are provided with inspection windows, which are designed and positioned relative to the additional identifier of at least one bearing foil immediately following in the correct fitting order, so that the additional identifiers of at least two immediately consecutive bearing foils in the correct fitting order are only visible in the associated inspection window when the at least two bearing foils, in the correct fitting order, are correctly fitted. In this way, a proper arrangement of the different bearing foils can be ensured in a simple manner, both during manual assembly and during fully or partially automated assembly.

Another preferred exemplary embodiment of the foil thrust bearing is characterized in that the additional identifiers are designed and arranged so that the correct fitting order can be detected during assembly. Detection of the correct fitting order can be performed manually with the human eye and/or by means of a suitable camera system. Depending on the design and configuration of the additional identifiers in combination with the inspection windows, individual assembly steps can be monitored. However, it is also possible to manually or automatically check the complete fitting order after the assembly of the foil thrust bearing has been completed. Depending on the arrangement and design of the additional identifiers, it may also be possible to omit the previously described inspection windows. In this case, it must be ensured that the additional identifiers can be detected in a suitable manner when the foil thrust bearing is fitted.

A preferred exemplary embodiment of the foil thrust bearing is characterized in that the additional identifiers and/or the inspection windows are arranged in non-functional regions of the different bearing foils. This ensures that the different bearing foils are not compromised in their desired function when installed, for example in a compressor of a fuel cell system. The redesign of the foil bearings is advantageously quasi-cost-neutral, as their geometries are etched out of different coils. The additionally introduced identifiers and the change of hole patterns of the different bearing foils are thus not associated with significantly increased production costs.

Advantageously, only a one-time adjustment of negative masks is required for etching the different bearing foils. The associated production costs are marginal.

A preferred exemplary embodiment of the foil thrust bearing is characterized in that the additional identifiers comprise letters. The additional identifiers include, for example, capital letters of the alphabet. The letters are clearly visible on the different bearing foils, advantageously well visible both before installation and in the installed state. This significantly simplifies assembly of the foil thrust bearing.

A preferred exemplary embodiment of the foil thrust bearing is characterized in that the additional identifiers comprise optically automatically detectable symbols, such as dots, with a detection device. For example, the automatically detectable symbols may comprise different numbers of equally sized and highly visible dots. The automatically detectable symbols enable automated production, particularly large-scale production, in an especially advantageous manner.

A preferred exemplary embodiment of the foil thrust bearing is characterized in that the different bearing foils comprise two foil sets, each having a covering foil, a stop washer, a spacer washer, and a cover washer. Adjustment washers and, for example, an intermediate ring are arranged between the two foil sets to create the previously described intermediate space. The structure and design of foil thrust bearings are well known. The stop washers and the spacer washers, and possibly also the adjustment washers, can be made from a foil-like material. These washers are then also referred to as foils. The two foil sets advantageously include identical parts. This simplifies manufacturing. However, assembly problems may arise, which are solved by the additional identifiers, particularly in combination with the inspection windows.

A preferred exemplary embodiment of the foil thrust bearing is characterized in that the two foil sets are oriented via three asymmetrically arranged pins. The pins are attached to a bearing plate, for example. The disclosed foil thrust bearing preferably comprises two such bearing plates, between which the two foil sets with the adjustment washers and, if necessary, the intermediate ring are arranged. The two foil sets are advantageously axially clamped between the two bearing plates with the adjustment washers and the intermediate ring in between.

In a method for fitting a previously described foil thrust bearing, the above-mentioned task is alternatively or additionally solved by checking whether the additional identifiers are visible and correctly arranged during the assembly of the different bearing foils.

With the implementation of the previously described geometric adjustments to the different bearing foils, which include, for example, additional identifiers and, if necessary, also inspection windows on the different bearing foils, it is ensured that the different bearing foils are not fitted in an incorrect installation position. Furthermore, visual inspection of the correct mounting position and order of the different bearing foils is enabled manually or by means of a suitable camera system. This avoids complaints or failures during testing or in the field due to incorrect assembly of the thrust bearing foils. Staff training is simplified. In particular, error-free assembly is also enabled if the assembly location is not visible or can only be viewed to a limited extent.

The invention optionally also relates to a gas supply device with a rotor that is supported by a previously described foil thrust bearing. The gas supply device is preferably an electrically powered air compressor that provides air in a fuel cell system.

The invention optionally also relates to a foil set, in particular a bearing foil, and/or a bearing plate for a previously described foil thrust bearing. The mentioned parts can be procured separately.

Further advantages, features, and details of the invention arise from the following description, in which exemplary embodiments are described in detail with reference to the drawings.

### BRIEF DESCRIPTION OF THE DRAWINGS

Shown are:

FIG. 1 is an exploded view of a foil thrust bearing with different bearing foils;

FIG. 2 is a top view of a stop washer of the foil thrust bearing from FIG. 1 with a symmetrical hole pattern;

FIG. 3 is a bolt circle of the stop washer from FIG. 2 to illustrate the differences between the stop washer in FIG. 2 and an exemplary embodiment of the stop washer with an asymmetric hole pattern;

FIG. 4 is a top view of a stop washer with an asymmetric hole pattern;

FIG. 5 is a schematic perspective view of the foil thrust bearing from FIG. 1 with inspection windows on the different bearing foils; and

FIG. 6 shows a similar representation as in FIG. 5 with additional identifiers on the different bearing foils.

### DETAILED DESCRIPTION

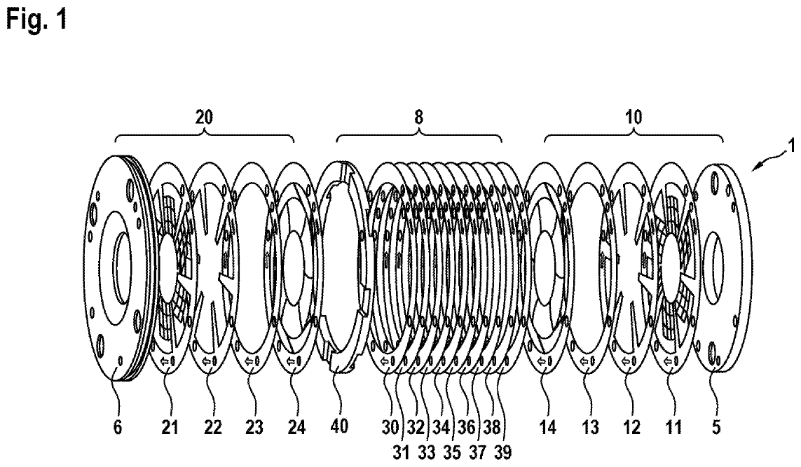

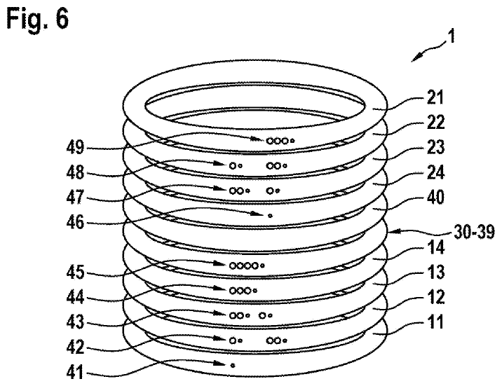

FIG. 1 shows an exploded view of a foil thrust bearing 1. In FIGS. 5 and 6, the foil thrust bearing 1 is shown schematically in perspective view to illustrate exemplary embodiments of the foil thrust bearing 1 with additional identifiers 41 through 49 and/or with inspection windows 50 through 60.

The foil thrust bearing 1 comprises two foil sets 10; 20. The foil sets 10; 20 each include a spring foil 11; 21, a stop washer 12; 22, a spacer washer 13; 23, and a covering foil 14; 24. The construction and function of such foil thrust bearings 1 are known.

In an axial intermediate space 8 between the two foil sets 10 and 20, adjustment washers 30 through 39 and an intermediate ring 40 are arranged. The adjustment washers 30 through 39 serve to create a defined distance between the two foil sets 10, 20.

Radially within the adjustment washers 30 through 39, in the fitted state of the foil thrust bearing 1, a non-illustrated thrust bearing washer is arranged, which serves, for example, on a rotor of a compressor to provide axial bearing for the rotor with the foil thrust bearing 1. The thrust bearing washer can be connected to a shaft in one piece and can also be referred to as the disk-shaped region of the rotor.

In the fitted state, the foil thrust bearing 1 comprises the disk-shaped region of the rotor on both sides, i.e., on the left side and right side in FIG. 1, radially within the adjustment washers 30 through 39 and the intermediate ring 40 in the axial intermediate space 8. The disk-shaped region or the thrust bearing washer of the rotor can come to a stop on the left side as well as on the right side in the installed state of the foil thrust bearing 1. Between the disk-shaped region and the adjacent components, the foil sets 10, 20 of the foil thrust bearing 1 are located respectively.

During assembly, the spring foil 21, also referred to as a spring sheet or bump foil, is first fitted on the left side. The spring foil 21 is oriented using three pins, which are arranged 120 degrees apart in the peripheral direction in conventional foil thrust bearings and are accommodated in the bearing plate 6.

Subsequently, the assembly of the stop washer 22, also referred to as the overstroke stop washer, is carried out. The spacer washer 23 and the covering foil 24, also referred to as top foil, are then assembled. When correctly installed, the covering foil or top foil 24 serves to establish an air gap with the rotor's thrust bearing washer, also referred to as a rotor washer, during the rotor's operation.

On the right side, the bearing assembly takes place in the same manner. The resulting and measured intermediate space 8 is bridged with a suitable number of adjustment washers 30 through 39. This ensures that all different bearing foils or bearing washers of the foil sets 10, 20 are correctly and stably clamped between the two bearing plates 5, 6. The so-called intermediate ring 40 is arranged between the covering foil 24 and the adjustment washer 30.

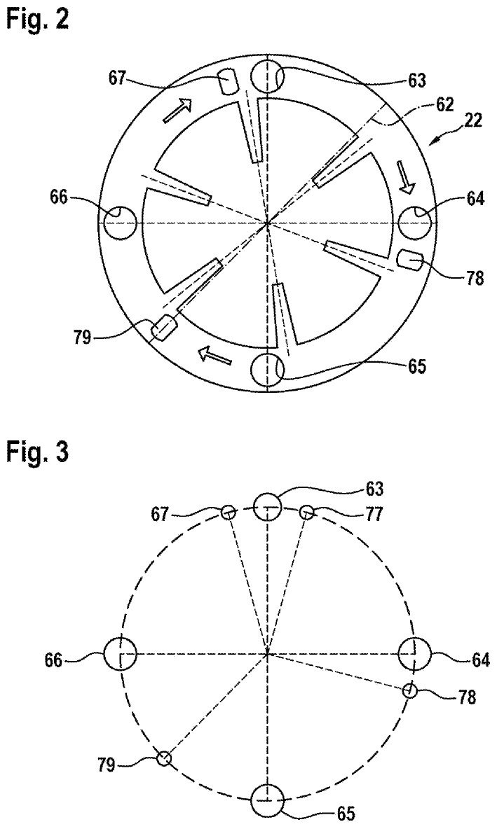

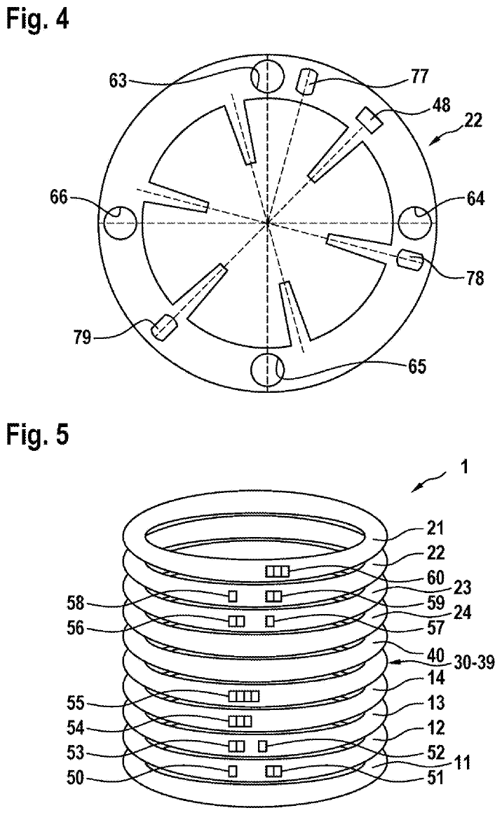

FIG. 2 shows that the stop washer 22 can have a symmetrical hole pattern with symmetrically arranged position holes 67, 78, 79 relative to a symmetry line 62. FIG. 4 illustrates that the stop washer 22 is advantageously equipped with an asymmetrical hole pattern, which comprises asymmetrically arranged position holes 77, 78, 79.

FIGS. 2 and 4 show that the stop washer 22 in both versions, i.e. with both symmetrical and asymmetrical hole patterns, has a total of four screw holes 63, 64, 65, 66. The screw holes 63 through 66 are used to insert screws to fasten the foil thrust bearing 1.

In addition, the stop washer 22 includes the three position holes 67; 78, 79, which are arranged symmetrically in FIG. 2 with respect to the line of symmetry 62, while the position holes 77 through 79 in FIG. 4 are deliberately arranged asymmetrically. In addition, the stop washer 22 in FIG. 4 is provided with an additional identifier 48.

The asymmetrical arrangement of the three pins and the position holes 77 through 79 prevents unwanted twisting of the foils and washers of the foil sets 10, 20. Furthermore, the asymmetrical arrangement of the position holes 77 through 79 prevents the front and back sides from being accidentally swapped during assembly.

The Poka-Yoke principle applies to the installation of each individual bearing foil of the foil sets 10 and 20. This completely eliminates the need to consider the direction of rotation or the front and back side of the bearing foils during assembly.

FIG. 6 indicates that the foils and washers 11 through 14; 21 through 24 of the foil sets 10; 20 are provided with additional identifiers 41 through 49 in accordance with an essential aspect of the invention. The additional identifiers 41 through 49 are attached to the edge of the foil according to the respective technical drawing underlying the construction of the foil sets 10; 20. The additional identifiers 41 through 49 advantageously include permanently assigned capital letters.

According to a preferred exemplary embodiment, the foils and washers 11 through 14, 30 through 39, 40 and 21 through 24 comprise capital letters A, B/H, C/G, D, E, F, C/G, B/H and J in an order ascending from bottom to top in FIG. 6, from A through J. These bearing foils or bearing washers are fitted in sequence in the ascending order of the alphabet.

FIG. 5 indicates that the bearing washers and bearing foils of the foil sets 10, 20 are equipped with inspection windows 50 through 60 in addition to the additional identifiers 41 through 49 shown in FIG. 6. The inspection windows 50 through 60 are advantageously provided in peripheral regions of the foils or washers of the foil sets 10, 20.

The inspection windows 50 through 60 advantageously serve to make underlying or hidden foils or washers, or additional identifiers on these foils or washers, visible. The inspection windows 50 through 60 are advantageously dimensioned small enough to prevent incorrect assembly using the three pins described above.

When the two foil sets 10, 20 are properly assembled, a defined identifier arrangement, also referred to as a visual image, A-B-C-D-E-F-G-H-J is created. This visual image can advantageously be checked both by the fitting employee during assembly and by a suitable camera system.

Alternatively, for a camera inspection, corresponding dots shown in FIG. 6 may be used instead of the previously described letters. Using dots as additional identifiers 41 through 49 facilitates optical detection with a suitable camera system.

The stop washers 12; 22, which are also referred to as stroke stop washers, and the spacer washers 13; 23 are particularly advantageous as identical parts. This is not affected by the additional identifiers B/H and C/G, since the unneeded inspection windows and letters are covered by the foil above or below them or by a foil arranged next to them, depending on the principle, underlying or adjacently arranged foil.

1. A foil thrust bearing (1) having different bearing foils (11-14; 21-24) which are fitted in a defined position and in a specific sequence on two sides of an axial intermediate space (8), wherein the different bearing foils (11-14; 21-24) are provided with additional identifiers (41-49) which are visible on the different bearing foils (11-14; 21-24) in a defined identifier arrangement only when the different bearing foils (11-14; 21-24) are mounted and correctly positioned in a correct fitting order.

2. The foil thrust bearing according to claim 1, wherein the different bearing foils (11-14; 21-24) are provided with inspection windows (50-60) which are configured and positioned relative to the additional identifier (41-49) of a respective at least one bearing foil immediately following in the correct fitting order such that the additional identifiers of at least two bearing foils immediately following one another in the correct fitting order are visible in the associated inspection window only if the at least two bearing foils immediately following one another in the correct fitting order are correctly mounted.

3. The foil thrust bearing according to claim 1, wherein the additional identifiers (41-49) are configured and arranged such that the correct fitting order can be detected during assembly.

4. The foil thrust bearing according to claim 2, wherein the additional identifiers (41-49) and/or the inspection windows (50-60) are arranged in non-functionally relevant regions of the different bearing foils (11-14; 21-24).

5. The foil thrust bearing according to claim 1, wherein the additional identifiers (41-49) comprise letters.

6. The foil thrust bearing according to claim 1, wherein the additional identifiers (41-49) comprise optically detectable symbols, that are automatically detectable with a detection means.

7. The foil thrust bearing according to claim 1, wherein the different bearing foils (11-14; 21-24) comprise two foil sets (10, 20) each having a covering foil (11, 21), a stop washer (12, 22), a spacer washer (13, 23) and a cover washer (14, 24).

8. The foil thrust bearing according to claim 7, wherein the two foil sets (10, 20) are oriented by three asymmetrically arranged pins.

9. A method for fitting a foil thrust bearing (1) according to claim 1, wherein during assembly of the different bearing foils (11-14; 21-24), it is checked whether the additional identifiers (41-49) are visible and correctly arranged.

10. A foil set (10, 20) and/or bearing plate (5, 6) for a foil thrust bearing (1) according to claim 1.

11. The foil thrust bearing according to claim 6, wherein the additional identifiers (41-49) comprise dots.
